(19) United States
(12) Patent Application Publication
(10) Pub. No.: US 2011/0175791 A1
(43) Pub. Date: Jul. 21, 2011

(54) MULTI-BEAM, POLARIZATION DIVERSITY NARROW-BAND COGNITIVE ANTENNA

(75) Inventors: Tayfun Ozdemir, Ann Arbor, MI (US); Andrzej M. Pawlak, Rochester Hills, MI (US)

(73) Assignees: DELPHI TECHNOLOGIES, INC., TROY, MI (US); MONARCH ANTENNA, INC., ANN ARBOR, MI (US)

(21) Appl. No.: 13/119,089

(22) PCT Filed: Sep. 18, 2009
(86) PCT No.: PCT/US09/57441

§ 371 Date: Mar. 15, 2011

Related U.S. Application Data
(60) Provisional application No. 61/192,549, filed on Sep. 19, 2008.

(51) Int. Cl. H01Q 3/24

(52) U.S. Cl. 343/876

(57) ABSTRACT

A multi-beam, polarization diversity, narrow-band cognitive antenna system is disclosed. The antenna system includes a plurality of antenna elements, switching elements, and transmission feed lines disposed on a PCB substrate, inside or on the enclosure of a consumer wireless device, on the airframe of an air vehicle, or on the surface of a ground vehicle. The plurality of switching elements are arranged with the antenna elements and transmission feed lines to, when selectively closed, electrically couple selected ones of the antenna elements and transmission feed lines to one another to generate an antenna configuration selected from a plurality of antenna configurations. A non-volatile memory is configured to store data representing at least some of the plurality of antenna configurations. A control arrangement operatively coupled to the plurality of switching elements and configured to close selected ones of the switching elements as a function of the data stored in said memory. Means are provided to selectively update the data on a function of previously selected antenna configurations.

### FIELD OF THE INVENTION

This disclosure relates generally to wireless communication systems. More particularly, this disclosure relates to smart antennas including self-structuring antenna subsystems and self-structuring feeds operating in different beam modes.

### BACKGROUND OF THE INVENTION

The vast majority of vehicles currently in use incorporate vehicle communication systems for receiving or transmitting signals. For example, vehicle audio systems provide information and entertainment to many motorists daily. These audio systems typically include an AM/FM radio receiver that receives radio frequency (RF) signals. These RF signals are then processed and rendered as audio output. A vehicle communication system may incorporate other functions, including, but not limited to, wireless data and voice communications, global positioning system (GPS) functionality, and satellite-based digital audio radio services (SDARS). The vehicle communication system may also incorporate remote function access (RFA) capabilities, such as remote keyless entry, remote vehicle starting, seat adjustment, and mirror adjustment.

Communication systems, including vehicle communication systems, typically employ antenna systems including one or more antennas to receive or transmit electromagnetic radiated signals. In general, such antenna systems have predetermined patterns and frequency characteristics. These predetermined characteristics are selected in view of various factors, including, for example, the ideal antenna RF design, physical antenna structure limitations, and mobile environment requirements. Because these factors often compete with each other, the resulting antenna design typically reflects a compromise. For example, an antenna system for use in an automobile or other vehicle preferably operates effectively over several frequency bands (e.g., AM, FM, television, RFA, wireless data and voice communications, GPS, and SDARS), having distinctive narrowband and broadband frequency characteristics and distinctive antenna pattern characteristics within each band. Such antenna systems also preferably are capable of operating effectively in view of the structure of the vehicle body (i.e., a large conducting structure with several aperture openings). The operating characteristics (i.e., transmitting and receiving characteristics) of such antenna systems preferably are independent of the vehicle body style, orientation, and weather conditions. To accommodate these design considerations, a conventional vehicle antenna system can use several independent antenna systems and still only marginally satisfy basic design specifications.

Significant improvement in mobile antenna performance can be achieved using an antenna that can alter its RF characteristics in response to changing electrical and physical conditions. One type of antenna system that has been proposed to achieve this objective is known as a self-structuring antenna (SSA) system. An example of a conventional SSA system is disclosed in U.S. Pat. No. 6,175,723, entitled “SELF-STRUCTURING ANTENNA SYSTEM WITH A SWITCHABLE ANTENNA ARRAY AND AN OPTIMIZING CONTROLLER,” to Rothwell III (“the '723 patent”). The SSA system disclosed in the '723 patent employs antenna elements that can be electrically connected to one another via a series of switches to adjust the RF characteristics of the SSA system as a function of the communication application or applications and the operating environment. A feedback signal provides an indication of antenna performance and is provided to a control system, such as a microcontroller or microcomputer that selectively opens and closes the switches. The control system is programmed to selectively open and close the switches in such a way as to improve antenna optimization and performance.

Conventional SSA systems may employ several switches in a multitude of possible configurations or states. For example, an SSA system that has 24 switches, each of which can be placed in an open state or a closed state, can assume any of 16,777,216 (2²⁴) configurations or states. Assuming that selecting a potential switch state, setting the selected switch state, and evaluating the performance of the SSA using the set switch state each takes 1 ms, the total time to investigate all 16,777,216 configurations to select an optimal configuration is 50,331.6 seconds, or approximately 13.98 hours. During this time, the SSA system loses acceptable signal reception.

The search time associated with selecting a switch configuration may be improved by limiting the number of configurations that may be selected. For example, if the control system only evaluates 0.001% of the possible switch configurations, the search time can be reduced to slightly less than a second. Laboratory experiments have demonstrated that search times can be made significantly shorter. Nevertheless, the loss of acceptable signal reception every time an SSA system is tuned to a new station, channel, or band is still a significant problem.

Still, known SSA technology is limited to a basic configuration that uses a single point feed system connected to a single port antenna template having a large number of switches. This restriction has a negative impact on its potential performance and flexibility for many applications.

Still, known SSA technology does not provide a roadmap for generating multiple beams over a relatively narrow frequency band (which most of today's consumer wireless and machine-to-machine communication applications require) without sacrificing antenna efficiency.

In wireless communication systems, portable or mobile subscriber units communicate with a centrally located base station within a cell. The wireless communication system systems may be called a CDMA2000, GSM or WLAN communication system, for example. The subscriber units are provided with wireless data and/or voice services by the system operator and can connect devices such as, laptop computers, personal digital assistants (PDA's), cellular telephones or the like through the base station network.

Each subscriber unit is equipped with an antenna. To increase the communications range between the base station and the mobile subscriber units, and for also increasing network throughput, smart antennas may be used. Smart antennas may also be used with access points and client stations in WLAN communication systems. A smart antenna includes a switched beam antenna or a phased array antenna, for example, and generates directional antenna beams.

A switched beam antenna includes an active antenna element and one or more passive antenna elements. Each passive antenna element is connected to a respective impedance load by a corresponding switch. By selectively switching the passive antenna elements to their impedance load, a desired antenna pattern is generated. When a passive antenna element is connected to an inductive load, radio frequency (RF) energy is reflected back from the passive antenna element towards the active antenna element. When a passive antenna element is connected to a capacitive load, RF energy is directed toward the passive antenna element away from the active antenna element. A switch control and driver circuit provides logic control signals to each of the respective switches.

For a switched beam antenna comprising an active antenna element and two passive antenna elements, for example, there are four different switching combinations for selecting a desired antenna beam if the switch is a single pole double throw (SPDT). Each switching combination corresponds to a different antenna beam mode, and consequently, the input impedance to the active antenna element changes between the different modes. The efficiency of the smart antenna varies as the input impedance varies.

Similarly, in a phased array antenna, when the relative phases fed to the respective antenna elements are changed, the input impedances also vary. The phase changes are integral to the beam scanning and adaptive beam forming of a phased array antenna. This makes it difficult to match the input impedances of the various modes. To obtain a reasonable match for required beam shapes and positions, dynamic matching circuits are often used, which further add to the complexity and cost of a phased array antenna.

### SUMMARY OF THE INVENTION

Therefore, it is an object of the present invention to provide a new, simplified antenna that produces a narrow beam of reception (or transmission) pattern over a variety of possible look angle segments.

In the preferred embodiments of the invention, a cognitive or smart antenna structure is provided which senses the environment and provides means for controlling the particular angular sector over which the narrow beam is formed and, at the same time, maintains power efficiency, resulting in a high gain antenna. Each “narrow beam” is narrower in angular span with higher gain compared to a half-wavelength resonant antenna. Prior cognitive antennas, known as self-structuring antennas (SSA), upon which the present invention builds, provide a “general” or formative concept of creating apertures out of sub-resonant” antenna elements inter-connected via RF switches to maximize received/transmitted signal strength without regard to antenna power efficiency. Prior SSA's also typically describe wide-band operation and do not address narrow-band features.

The present invention is unique in that it addresses a method of achieving an adaptive high-gain, multi-beam antenna over a relatively narrow frequency band using principles of cognitive antennas, provides methods of maintenance of power efficiency, and describes a systematic method of improving performance by increasing antenna size.

The present invention provides a simple solution of forming a narrow beam cognitive antenna that preserves its power efficiency and operates over a narrow frequency band. This is accomplished by employing a plurality of resonant and/or sub-resonant antenna elements as well as lumped and distributed inductors and capacitors (realized via discrete components or as part of the antenna structure) that, through selective connection and disconnection actions, can form highly efficient narrow beam antennas. The present invention also provides a systematic approach to increasing the gain and the number of possible beams (or patterns) by varying the size and component count of the antenna while maintaining the narrow frequency band of operation.

The solutions provided by the subject invention are based on active connecting and disconnecting of the plurality of sub-resonant antenna elements in a manner to form highly efficient narrow beam and/or polarization diversity antennas in a variety of arrangements.

One approach involves engaging either resonant or sub-resonant antenna elements only to form highly efficient narrow beam antennas in one of two variations. In one variation, operating antenna elements are disposed in close proximity to each other without an electrical connection between them. In the other variation, operating antenna elements are disposed in close proximity to each other with an electrical connection among some or all of them.

A second approach involves engaging a plurality of resonant and/or sub-resonant antenna elements to form highly efficient narrow beam antennas in one of two variations. In one variation, operating antenna elements are disposed in close proximity to each other without an electrical connection between them. In the other variation, operating antenna elements are disposed in close proximity to each other with an electrical connection among some or all of them.

A third approach involves altering the feed-point to the antenna structure.

A fourth approach involves feeding the antenna structure at multiple points through a feed network.

Using this methodology, a polarization diversity narrow-band cognitive antenna can be realized by means of:

(1.) Utilizing typical Self-Structuring Antenna (SSA) functions to achieve optimum signal gain through sensing the environment and providing best reception (or transmission) signal Quality;

(2.) Utilizing typical Self-Structuring Feed (SSF) networks to achieve a variety of polarizations and maintain impedance match between the antenna structure and the radio receivers;

(3.) Using Radio Frequency (RF) switches to create or remove a conductive path;

(4.) Altering the electrical configuration of the antenna aperture by optimizing how the resonant and/or sub-resonant antenna elements are combined together;

(5.) Using a plurality of various resonant and/or sub-resonant antenna structure elements which could be made of patches, slots, conductive wires, cavities, dielectrics or a combination thereof;

(6.) Using a variety of lumped and distributed inductances and capacitances, either as add-on components or realized as part of the antenna structure;

(7.) Using a variety of ways to redirect the electric current on the aperture or inside the antenna structure or alter the field above, under or inside the antenna structure by creating or moving conductive paths distributed throughout the antenna structure; and/or

(8.) By (a.) connecting or disconnecting patch or wire elements, (b.) short-circuiting or open-circuiting slot elements, (c.) introducing conducting pins inside a cavity and having them short-circuit the cavity or leaving them standing inside the cavity.

The above described method is believed to provide the best means of maintaining the antenna power efficiency to achieve higher gain while maintaining the impedance match to the feed network over the frequency band of operation.

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is a block diagram illustrating an antenna system according to an embodiment;

FIG. 2, is a block diagram illustrating a communication system according to an embodiment;

FIG. 3, is a flow diagram illustrating a method to configure an antenna system according to an embodiment;

FIG. 4, is a block diagram illustrating a communication system according to an embodiment;

FIG. 5, is a block diagram illustrating a communication system according to an embodiment;

FIG. 6, is a block diagram illustrating an antenna made up of several antenna and other circuit elements setup with a reconfigurable feed network, wherein both sections contain switches for structuring purposes;

FIG. 7, is a block diagram of an antenna assembly containing resonant and sub-resonant antenna elements;

FIG. 7a, is a portion of the antenna assembly of FIG. 7, on an enlarged scale, illustrating multiple conductive paths between resonant and sub-resonant antenna elements including RF switches, inductors and capacitors;

FIG. 8, is a block diagram of an antenna assembly illustrating the connection of resonant antenna elements, wherein the arrangement of a central resonant element and surrounding four resonant elements (in this case) are interconnected by conductive paths that may contain an inductor or capacitor and RF switches;

FIG. 9, is a block diagram illustrating slot elements etched on the metal for control of resonant frequency and size reduction of the overall antenna;

FIG. 10, is a plan view of a patch antenna element containing multiple shorting pins, inductors and/or capacitors and RF switches located in the cavity of the patch antenna element of an antenna assembly;

FIG. 11, is a cross-sectional view of the patch antenna element of FIG. 10;

FIG. 11a, is, is a portion of the antenna assembly of FIGS. 10 and 11, on an enlarged scale, illustrating a single conductive path between the patch antenna element and a ground plane including RF switches, inductors and capacitors;

FIG. 12, is a block diagram illustrating a polarization diversity of the antenna provided by SSF with two feeds having perpendicular locations with an RF input and switch;

FIG. 13, is a block diagram illustrating sub-resonant antenna elements similar to that of FIG. 7 wherein the antenna radiation pattern is steered to different directions by various combinations of switch states;

FIG. 14, is a depiction of multiple beams extending in multiple directions resulting from operation of the multi-beam antenna of FIG. 13;

FIG. 15, is a block diagram illustrating an antenna assembly having a multiplicity of connecting resonant and/or sub-resonant elements that feature different directions of the antenna pattern based on a various combinations of switch states; and

FIG. 16, is a depiction of multiple narrow beams extending in multiple directions resulting from operation of the multi-beam antenna of FIG. 15.

Although the drawings represent embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DETAILED DESCRIPTION

Technological advances in radio-frequency (RF) front-ends, such as reconfigurable antenna arrays, afford a new “hardware” dimension for dynamic spectrum access in cognitive wireless networks.

A smart antenna system is able to provide, if compared with existing technologies, higher system capacity, improved quality of service, suppress interferences, improved power consumption and higher frequency reuse. From a practical point of view, a smart antenna system combines an antenna array with digital signal processing techniques (adaptive beamforming techniques, direction of arrival procedures, etc.) in order to obtain a software steerable antenna pattern and direct the radiated power in (or receive from) the desired direction only.

A cognitive antenna is substantially an antenna array able to provide a spatial-temporal scanning of the radio environment, and it is able to reconfigure itself in order to perform optimized communication capabilities.

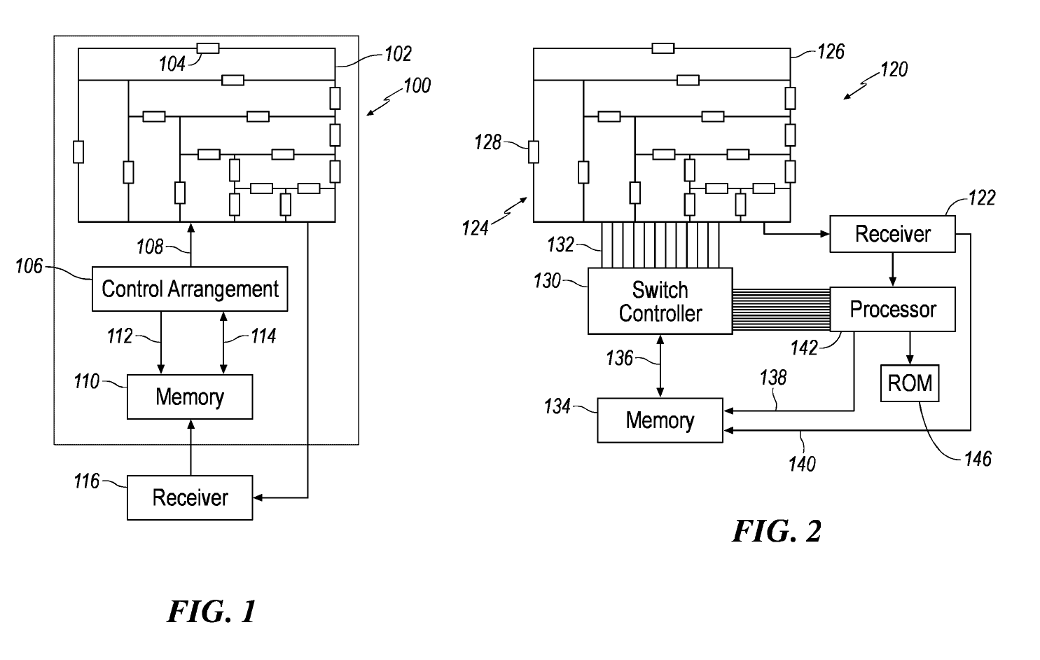

Referring to FIG. 1, a self-structuring antenna (SSA) system is shown generally at 100 according to an embodiment. Antenna elements 102 are arranged with switching elements 104 in any desirable pattern, such as the illustrated pattern depicted in FIG. 1. It will be appreciated that the antenna elements 102 and the switching elements 104 can be arranged in patterns other than the exemplary pattern depicted in FIG. 1. Such patterns can be designed for acceptable performance under certain operating conditions.

As illustrated, the antenna elements 102 are depicted as solid line segments, and can be implemented in practice, for example, by wires or other conductors, including but not limited to conductive traces. Alternatively, patches or other radiating devices may also be used to implement one or more of the antenna elements 102.

The switching elements 104, which are shown generally as rectangles in FIG. 1, are controllably placed in an open state or a closed state via application of an appropriate control voltage or control signal. The switching elements 104 may be implemented in practice by using bipolar junction transistors (BJTs) controlled by applying an appropriate base voltage. Alternatively, the switching elements 104 may be implemented using field-effect transistors (FETs) controlled by applying an appropriate gate voltage. In yet another embodiment, the switching elements 104 may also be implemented using a combination of BJTs, FETs, integrated circuits (ICs), and the like. Even further, in another embodiment, the switching elements 104 can be implemented using mechanical devices, such as relays or miniature electromechanical system (MEMS) switches. For purposes of clarity, control terminals and control lines connected to individual switching elements 104 are not illustrated.

Closing a switching element 104 establishes an electrical connection between any antenna elements 102 to which the switching element 104 is connected. Opening a switching element 104 disconnects the antenna elements 102 to which the switching element 104 is connected. Accordingly, by closing some switching elements 104 and opening other switching elements 104, various antenna elements 102 can be selectively connected to form different configurations. Selecting which switching elements 104 are closed enables the antenna system 100 to implement a wide variety of different antenna shapes, including but not limited to loops, dipoles, stubs, or the like. The antenna elements 102 need not be electrically connected to other antenna elements 102 to affect the performance of the antenna system 100, rather, each antenna element 102 forms part of the antenna system 100 regardless of whether the antenna element 102 is electrically connected to adjacent antenna elements 102.

A control arrangement, which is shown generally at 106, selects particular switching elements 104 to be opened or closed to form a selected antenna configuration. The control arrangement 106 is operatively coupled to the switching elements 104 via control lines (e.g., a control bus 108). The control arrangement 106 may incorporate, for example, a switch controller module and a processor, which is seen generally at 130 and 142, respectively in FIG. 2.

To select particular switching elements 104 to be opened or closed, the control arrangement 106 selects an antenna configuration. When the antenna system 100 is first activated, the control arrangement 106 searches the conceptual space of possible antenna configurations to identify an antenna configuration that will produce acceptable antenna performance under the prevailing operating conditions. To increase the speed of the search process, a memory 110 stores antenna configurations (e.g., switch states that are expected to produce acceptable antenna performance).

The memory 110 is operatively coupled to the control arrangement 106, for example, via an address bus 112 and a data bus 114. The memory 110 may be implemented using any of a variety of conventional memory devices, including, but not limited to, random access memory (RAM) devices, static random access memory (SRAM) devices, dynamic random access memory (DRAM) devices, non-volatile random access memory (NVRAM) devices, and non-volatile programmable memories, such as, for example, programmable read only memory (PROM) devices and electronically-erasable programmable read only memory (EEPROM) devices. The memory 110 may also be implemented using a magnetic disk device or other data storage medium.

The memory 110 can store the antenna configurations or switch states using any of a variety of representations. In some embodiments, each switching element 104 may be represented by a bit having a value of “1” if the switching element 104 is open or a value of “0” if the switching element 104 is closed in a particular antenna configuration. Accordingly, each antenna configuration is stored as a binary word having a number of bits equal to the number of switching elements 104 in the antenna system 100. The example antenna system 100 illustrated in FIG. 1 includes seventeen switching elements 104; therefore, according to the illustrated embodiment, each antenna configuration would be represented as a 17-bit binary word.

In some embodiments, multiple switching elements 104 may be controlled to assume the same open or closed state as a group. For example, as the antenna system 100 develops usage history, the control arrangement 106 may determine that performance benefits may result when certain groups of antenna elements 102 are electrically connected or disconnected. Alternatively, the determination to control such switching elements 104 as a group may be made at the time of manufacture of the antenna system 100. For example, certain zones formed by groups of antenna elements 102 may be controlled as a group for different frequency bands. When multiple switching elements 104 are controlled as a group, smaller binary words can represent antenna configurations or switch states. This more compact representation may yield certain benefits, particularly when the determination to control switching elements 104 as a group is made at the time of manufacture. In this case, the memory 110 may be implemented using a device having less storage capacity, potentially resulting in decreased manufacturing costs.

As the antenna system 100 is used, the control arrangement 106 updates the memory 110 to improve subsequent iterations of the search process. The control arrangement 106 causes the memory 110 to store binary words that represent the switch states for antenna configurations that are determined to produce acceptable antenna characteristics. Accordingly, when the control arrangement 106 repeats the search process (e.g., when the antenna system 100 is reactivated after having been deactivated), the search process can begin at an antenna configuration that is known to produce acceptable results. In conventional antenna systems lacking a memory 110, historical information is lost after each iteration of the search process (i.e., every time the communication system is turned off or tuned to a different communication band). Accordingly, in such conventional antenna systems, the search process begins anew with each iteration. By contrast, storing and using historical information relating to previous iterations of the search process can improve the speed of the search process.

The control arrangement 106 may read or update the memory 110 based on a control signal provided by a receiver 116, for example, when the communication system is activated. This control signal may be, for example, a received signal strength indicator (RSSI) signal generated as a function of an RF signal received by the receiver 116. Alternatively, the control signal may be generated as a function of an operational mode of the antenna system 100 (e.g., whether the antenna system 100 is to be configured to receive an AM or FM signal, a UHF or VHF television signal, a remote function access (RFA) signal, a global positioning system (GPS) signal, an SDARS signal, or a wireless data and voice communications signal, such as a CDMA or GSM signal. The control signal may also be generated as a function of the particular frequency or frequency band to which the receiver 116 is tuned.

When the control arrangement 106 receives the control signal from the receiver 116, the control arrangement 106 initiates the search process to select an antenna configuration in response to the control signal. The control arrangement 106 then addresses the memory 110 via the address bus 112 to access the binary word stored in the memory 110 that corresponds to the selected antenna configuration. The control arrangement 106 receives the binary word via the data bus 114, and, based on the binary word, outputs appropriate switch control signals to the switching elements 104 via the control bus 108. The switch control signals selectively open or close the switching elements 104 as appropriate.

FIG. 2 shows a communication system generally at 120 according to another embodiment. According to one possible implementation, the communication system 120 may be installed in a vehicle, such as, for example, an automobile, boat, train, or the like. Alternatively, the communication system 120 may be implemented as a standalone unit, e.g., a portable entertainment system, such as a walkman, boombox, or the like. A receiver 122 receives a radiated electromagnetic signal, such as an RF signal, via an antenna 124. Depending on the particular application, the radiated electromagnetic signal can be of any of a variety of types, including but not limited to an AM or FM radio signal, a UHF or VHF television signal, an RFA signal, a GPS signal, an SDARS signal, or a wireless data and voice communications signal, such as, for example, a CDMA or GSM signal.

The antenna 124 includes antenna elements and switching elements, which are shown generally at 126 and 128, respectively. As illustrated, the antenna and switching elements 126, 128 operate and are arranged in a similar manner as that shown and described above in FIG. 1. A switch controller 130 provides control signals to the switching elements 128 to selectively open or close the switching elements 128 to implement particular antenna configurations. The switch controller 130 is operatively coupled to the switching elements 128 via control lines 132.

The switch controller 130 is also operatively coupled to a memory 134, for example, via a bus 136. The memory 134 stores antenna configurations or switch states and is addressable using one or more lines 138, 140 extending from the processor 142 and receiver 122, respectively. It should be noted that the memory 134 need not store all possible antenna configurations or switch states. For many applications, it would be sufficient for the memory 134 to store up to a few hundred of the possible antenna configurations or switch states. Accordingly, any of a variety of conventional memory devices may implement the memory 134, including, but not limited to, RAM devices, SRAM devices, DRAM devices, NVRAM devices, and non-volatile programmable memories, such as PROM devices and EEPROM devices. The memory 134 may also be implemented using a magnetic disk device or other data storage medium.

As similarly described above, the memory 134 can store the antenna configurations or switch states using any of a variety of representations. In some embodiments, each switching element 128 may be represented by a bit having a value of “1” if the switching element 128 is open or a value of “0” if the switching element 128 is closed in a particular antenna configuration. Accordingly, each antenna configuration is stored as a binary word having a number of bits equal to the number of switching elements 128 in the antenna 124.

In operation, the processor 142 selects an antenna configuration appropriate to the operational state of the communication system 120 (i.e., the type of radiated electromagnetic signal received by the receiver 122 or the particular frequency or frequency band in which the communication system 120 is operating). For example, the receiver 122 may provide a control signal to the processor 142 or the memory 134 that indicates the operational mode of the antenna 124, e.g., whether the antenna 124 is to be configured to receive an AM, FM, UHF, VHF, RFA, CDMA, GSM, GPS, or SDARS signal. The receiver 122 may also generate the control signal as a function of the particular frequency or frequency band to which the receiver 122 is tuned. The control signal may also indicate certain strength or directional characteristics of the radiated electromagnetic signal. For example, the receiver 122 may provide a received signal strength indicator (RSSI) signal to the processor 142.

The processor 142 responds to the control signal by initiating a search process of the conceptual space of possible antenna configurations to select an appropriate antenna configuration. Rather than beginning at a randomly selected antenna configuration each time the search process is initiated, the processor 142 starts the search process at a switch configuration that is known to have produced acceptable antenna characteristics under the prevailing operating conditions at some point during the usage history of the communication system 120. For example, the processor 142 may address the memory 134 to retrieve a default switch configuration for a given operating frequency. If the default configuration produces acceptable antenna characteristics, the processor 142 uses the default switch configuration. On the other hand, if the default switch configuration no longer produces acceptable antenna characteristics, the processor 142 searches for a new switch configuration using the default switch configuration as a starting point. Once the processor 142 finds the new switch configuration, the processor 142 updates the memory 134 via the lines 138 to replace the default switch configuration with the new switch configuration.

Regardless of whether the processor 142 selects the default switch configuration or another switch configuration, the processor 142 indicates the selected switch configuration to the switch controller 130 via lines 144. The switch controller 130 then addresses the memory 134 via the bus 136 to access the binary word stored in the memory 134 that corresponds to the selected antenna configuration. The switch controller 130 receives the binary word via the bus 136, and, based on the binary word, outputs appropriate switch control signals to the switching elements 128 via the control lines 132. The switch control signals selectively opens or closes the switching elements 128 as appropriate, thereby forming the selected antenna configuration.

The processor 142 is typically configured to operate with one or more types of processor readable media, such as a read-only memory (ROM) device, which is shown generally at 146. Processor readable media can be any available media that can be accessed by the processor 142 and includes both volatile media, nonvolatile media, removable media, and non-removable media. By way of example, and not limitation, processor readable media may include storage media and communication media. Storage media includes both volatile, nonvolatile, removable, and non-removable media implemented in any method or technology for storage of information, such as, for example, processor-readable instructions, data structures, program modules, or other data. Storage media includes, but is not limited to, RAM, ROM, EEPROM, flash memory, CD-ROM, digital video discs (DVDs), magnetic cassettes, magnetic tape, magnetic disk storage, or any other medium that can be used to store any desired information that can be accessed by the processor 142. Communication media typically embodies processor-readable instructions, data structures, program modules or other data in a modulated data signal such as a carrier wave or other transport mechanism including any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also intended to be included within the scope of processor-readable media.

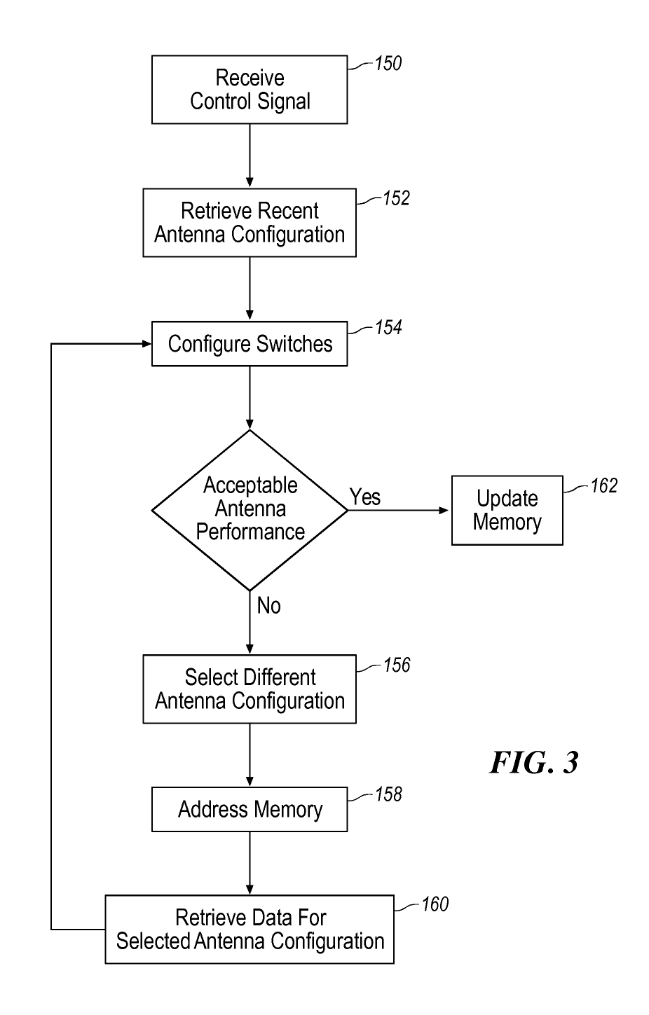

FIG. 3 is a flow diagram illustrating an example method for configuring the antenna 124, according to another embodiment. The method may be performed, for example, in accordance with processor-readable instructions stored in the ROM 146. First, the processor 142 receives a control signal at step 150 from the receiver 122. As described above in connection with FIG. 2, the control signal may indicate the operational mode of the antenna 124 (e.g., the particular frequency or frequency band to which the receiver 122 is tuned). Alternatively, the control signal may indicate the impedance of the antenna 124. The control signal may also be an RSSI signal or other signal indicating certain strength or directional characteristics of the radiated electromagnetic signal. In addition, the control signal may be generated by a remote receiver other than the receiver 122, for example, to enable improved reception at the remote receiver.

In response to the control signal, the processor 142 selects an appropriate antenna configuration. Specifically, the processor 142 accesses the memory 134 to retrieve a recent antenna configuration at step 152, such as a default antenna configuration, that has produced or is expected to produce acceptable antenna characteristics in the current operational mode (e.g., for the current operating frequency or frequency band). The processor 142 then configures the switching elements 128 to produce the antenna configuration at step 154 by controlling the memory 134 to output data representing the antenna configuration. Based on this data, the switch controller 130 drives each switching element 128 to an open state or a closed state, as appropriate. The processor 142 evaluates the performance of the selected antenna configuration, for example, using an RSSI or other feedback signal provided by the receiver 122. If the selected antenna configuration produces acceptable antenna characteristics, the processor 142 uses that antenna configuration. On the other hand, if the selected antenna configuration does not produce acceptable antenna characteristics, the processor 142 selects a different antenna configuration at step 156. The processor 142 addresses, at step 158, the memory 134 and retrieves data representing the newly selected antenna configuration at step 160. Next, the processor 142 configures the switching elements 128 to produce the newly selected antenna configuration at step 154 and again evaluates the performance of the antenna configuration.

When the processor 142 identifies an antenna configuration that produces acceptable antenna characteristics, the processor 142 uses that antenna configuration. In addition, the processor 142 updates the memory 134 to replace the previously stored antenna configuration with the new antenna configuration at step 162. In this way, the communication system 120 adapts to changing environmental conditions, as well as changing conditions relating to the antenna 124 itself. For example, as the communication system 120 ages, certain antenna elements 126 or switching elements 128 may exhibit declining performance or stop functioning entirely. Accordingly, certain switch configurations that once produced acceptable antenna characteristics may no longer work as well. By updating the memory 134, such switch configurations can be eliminated from further consideration.

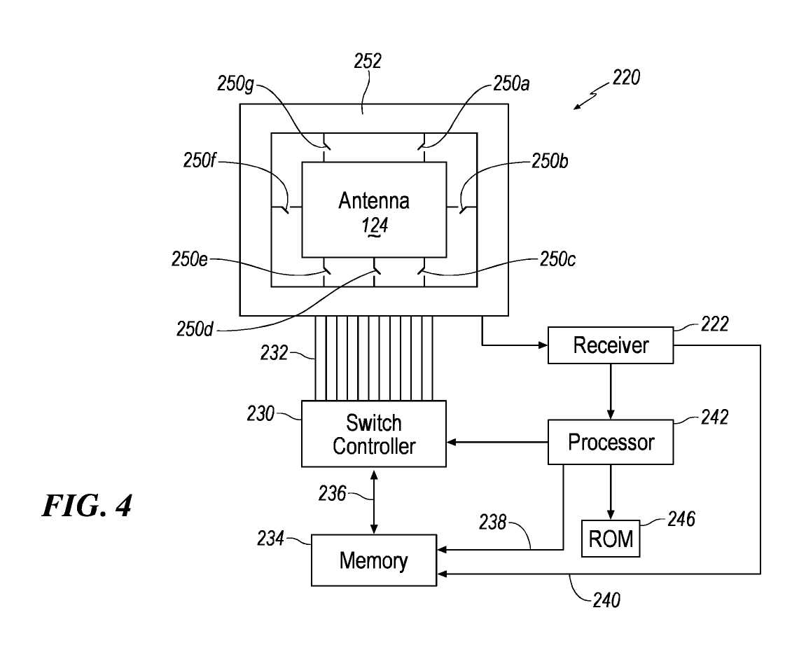

Referring to FIG. 4, a communication system is shown generally at 220 according to an embodiment including the self-structuring antenna 124. Self-structuring feed (SSF) ports or switches 250a-250g selectively interconnect the antenna 124 and a signal feed circuit in the form of a multiple feed template 252, a receiver 222 receives signals from the signal feed circuit 252, an SSF processor 242 receives an output signal from the receiver 222, an SSF switch controller 230 receives an output signal from the SSF processor 242, and control lines 232 interconnect the SSF controller 230 and switches 250a-250g.

The self-structure feed switches 250a-250g may selectively interconnect the antenna 124 and signal feed circuit 252 at respective spaced apart locations along a perimeter of the antenna 124. However, switches 250a-250g may be disposed at any location between the antenna 124 and the signal feed circuit 252. Moreover, although seven switches 250a-250g are shown, it will be appreciated that any desirable number of switches 250a-250g may be included.

In operation, each of the SSF feed switches 250a-250g may be independently actuated by the controller 230 between a first position in which the antenna 124 and signal feed circuit 252 are in communication though (a) switch(s) 250a-250g and a second position in which the antenna 124 and signal feed circuit 252 are not in communication through the switch(s) 250a-250g. Switches 250a-250g may function as a performance-adjusting device for improving the signal reception and/or signal transmission performance of the antenna 124. In one embodiment, the SSF switch controller 230 and SSF processor 242 control switches 250a-250g are dependent upon the signal received by the receiver 222 via the antenna 124.

The switches 250a-250g may begin in various combinations of the first and second positions when the antenna 124 passes a received signal to the receiver 222 via the switches 250a-250g and switch feed circuit 252. The SSF processor 242 may analyze an output signal from the receiver 222 to determine signal strength, signal-to-noise ratio, and/or some other attribute of the signal passed to the receiver 222. The SSF memory 234 may receive an analysis signal from the SSF processor 242 to record the performance of the antenna 124, as represented by the analysis and the position of the switches 250a-250g that produced that particular performance. The SSF switch controller 230 may then actuate at least one of the switches 250a-250g between the first and second positions to thereby provide an antenna arrangement with a different level of performance. The SSF memory 234 may again record the switch positions and the corresponding antenna performance produced thereby. The process may continue with the SSF switch controller 230 changing and recording switch positions and the resulting performance until the SSF processor 242 has determined a combination of switch positions that produces an optimal, favorable, or at least acceptable antenna performance.

The SSF processor 242 may try every possible combination of switch positions during the above process. Alternatively, the SSF processor 242 may only sample a number of combinations of switch positions and pick the best combination of the number sampled. As another alternative, the SSF switch controller 230 and processor 242 may include intelligence, which is shown generally at 234 and 246, respectively that enables the SSF switch controller 230 and processor 242 to systematically select particular switch combinations that are likely to yield good performance. The switch combinations may be selected, for example, based upon recognized patterns in the performance of previously selected combinations of switch positions.

Accordingly, the SSF switch controller 230 memory 234 may include an operational database for storing the best combination of switch positions for each of a list of possible operating conditions. Experimentation or trials to determine the best switch combinations may occur in the factory, in the field, and/or may be ongoing over the operational life of the antenna system.

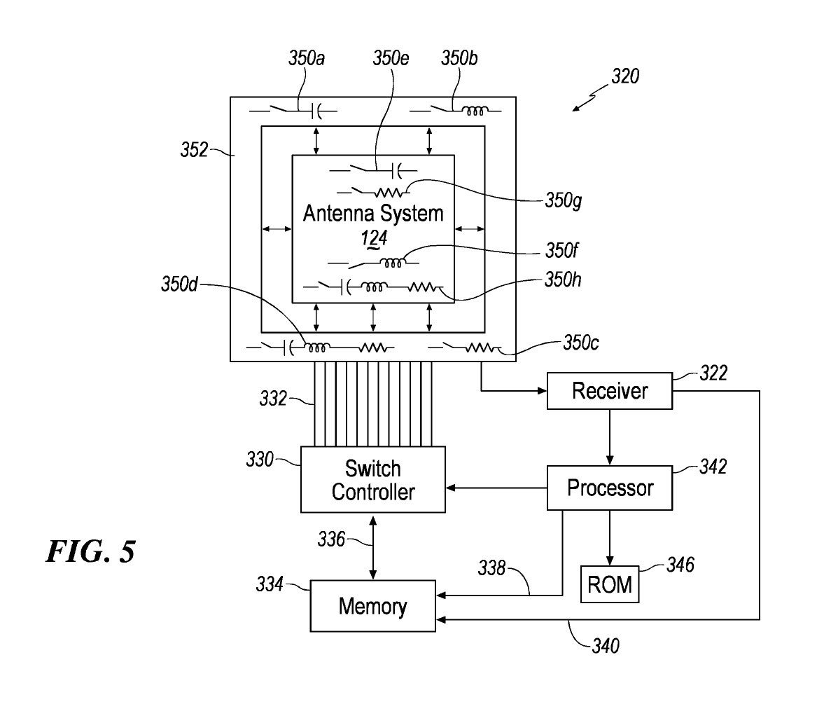

Referring to FIG. 5, a communication system is shown generally at 320 according to an embodiment including the self-structuring antenna 124. The communication system 320 includes switchable, self-structuring variable impedance elements (SSVIE) 350a-350h for selectively adding a variable impedance load to the antenna 124 and/or to a signal feed circuit 352. The elements 350a-350h are connected to the antenna 124 and signal feed circuit 352 and be may be used for impedance matching. A switchable capacitive load is seen at 350a, 350e. A switchable inductive load is seen at 350b, 350f. Switchable resistive loads are seen at 350c, 350g. Switchable capacitive, inductive, and/or resistive loads are seen at 350d, 350h. Any or all of the elements 350a-350d may be selectively connected in parallel and/or series with the signal feed circuit 352. Similarly, any or all of elements 350e-350h may be selectively connected in parallel and/or series with the antenna 124. Each of the elements 350a-350h has a respective switch device that may be actuated to thereby connect or disconnect the element 350a-350h to/from the antenna 124 and antenna feed circuit 352.

As illustrated, a receiver 322 receives signals from the signal feed circuit 352. An SSVIE processor 342 receives an output signal from the receiver 322. An SSVIE switch controller 330 receives an output signal from the SSVIE processor 342, and control lines 332 interconnect the SSVIE switch controller 330 and the switch devices of the elements 350a-350h. The elements 350a-350h may all have different impedance values, including different capacitances and different inductances. In one embodiment, the elements 350a-350h are sections of coaxial cable having different lengths and therefore, different impedances, i.e., different capacitances, inductances, and resistances. Generally, the SSVIE switch controller 330 control the elements 350a-350h dependent upon a signal received by the receiver 322 via the antenna 124. The SSVIE controller 330 and processor 342 may open and close the switch devices of the elements 350a-350h in different combinations and then determine which of the combinations results in the best antenna performance. As another alternative, the SSVIE switch controller 330 and processor 342 may include intelligence, which is shown generally at 334 and 346, respectively that enables the SSVIE switch controller 330 and processor 342 to systematically select particular element combinations that are likely to yield good performance.

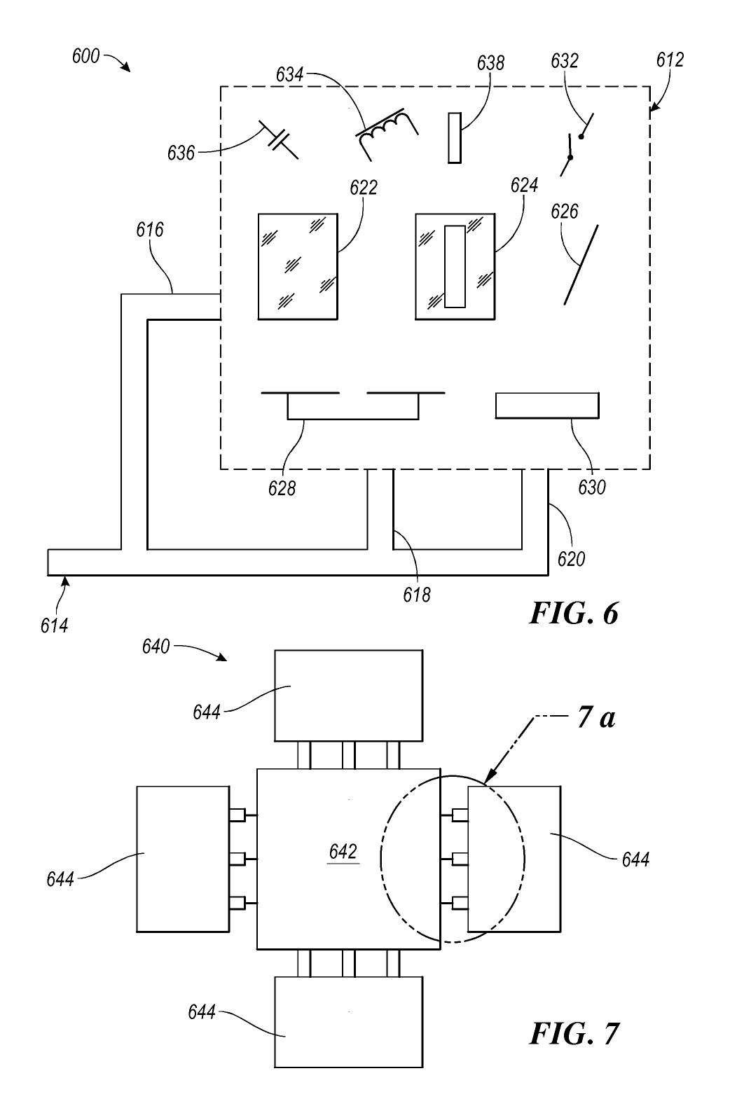

As demonstrated by the foregoing discussion, various embodiments may provide certain advantages. For instance, using the stored antenna configurations as a starting point for the process of searching for an antenna configuration that produces acceptable antenna characteristics under particular operating conditions may reduce the search time. In view of the improvements shown in FIGS. 1-5, performance of the SSA may be improved further by arraying self-structuring feed (SSF) and self-structuring variable impedance element (SSVIE) subsystems with the SSA. Referring now to FIG. 6, a communication system is shown generally at 420 according to an embodiment. The communication system 420 generally includes the same elements as the communication systems 120, 220, 320 shown in FIGS. 2, 4, and 5 with the exception that the communication system 420 includes one or more arrayed processors 422a-422c and switch controllers 430a-430c. Although the processors 422a-422c and switch controllers 430a-430c are shown in an arrayed pattern that are each respectively separated into three blocks for purposes of clarity in illustrating the concept, it will be appreciated that the function of each block shown at 422a-422c and 430a-430c may be incorporated into a single processor and switch controller, respectively, as suggested in FIGS. 2, 4, and 5.

The communication system 420 generally utilizes the concept of using a combination of the SSA, SSF, and SSVIE techniques shown in FIGS. 2, 4, and 5. According to an embodiment, the communication system 420 may be implemented for use as an AM/FM rear window glass antenna system in a vehicle, which is described in U.S. Pat. No. 7,558,555 B2 to L. Nagy, the specification of which is incorporated herein by reference. The communication system 420 uses various self-structuring techniques as sub-systems that form an aggregates system that uses the best of each SSA, SSF, and SSVIE sub-system, or, a combination of the sub-systems to obtain an optimum antenna solution for its application, for example to a rear window glass antenna system 500 of a vehicle, and its operating environment.

Referring to FIG. 6, a general set-up of an antenna system 610 is illustrated. Antenna system 610 includes a reconfigurable antenna 612 and a reconfigurable feed network 614 interconnected thereto through multiple, spaced-apart feeding locations 616, 618 and 620. The reconfigurable antenna 612 can contain various types of resonating elements such as patch elements 622, slot elements 624, wire elements 626, cavities 628 dielectrics 630, radio frequency (RF) switches (mechanical, solid state, MEMS) 632, inductors 634, capacitors 636 and shorting pins 638. Both the SSA 612 and reconfigurable feed 614 contain RF switches 632 for structuring purposes.

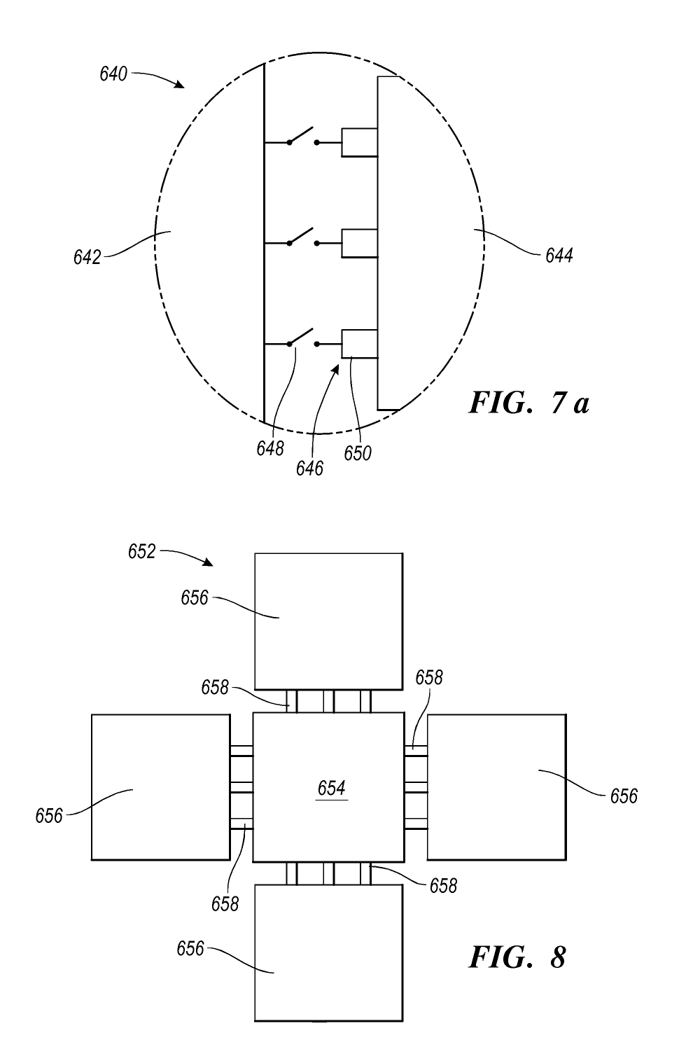

Referring to FIGS. 7 and 7a, an alternative embodiment reconfigurable antenna system 640 includes a central resonant element 642 peripherally enclosed by four sub-resonant elements 644. Adjacent portions of the resonant element 642 are interconnected with each of the sub-resonant elements 644 via multiple enlarged conductive paths 646 which contain an RF switch 648 in series with an element 650 such as a conductor, capacitor or inductor.

Referring to FIG. 8, another alternative embodiment reconfigurable antenna system 652 includes a central resonant element 654 peripherally enclosed by four additional resonant elements 656. Adjacent portions of the resonant elements 654 and 656 are interconnected via multiple enlarged conductive paths 658 which contain an RF switch in series with an element such as a conductor, capacitor or inductor as described in connection with FIGS. 7 and 7a.

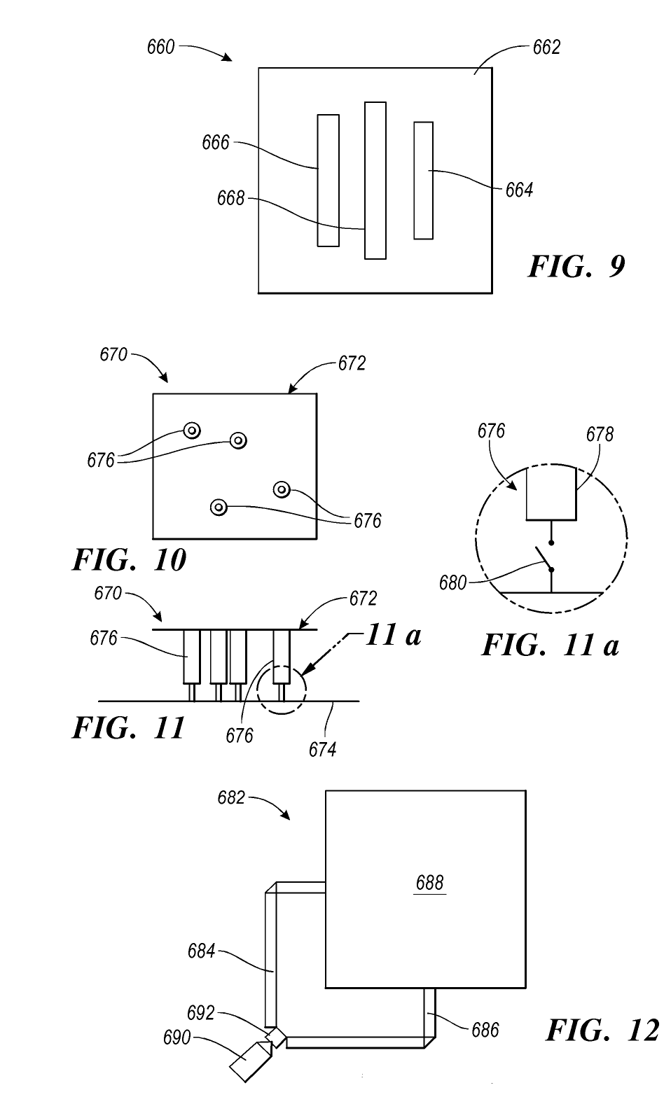

Referring to FIG. 9, another alternative embodiment reconfigurable antenna system 660 including a metallic antenna element 662 with several slot elements 664, 666 and 668 of varying sizes formed therein for control of resonant frequency and effecting size reduction of the antenna 660.

Referring to FIGS. 10, 11 and 11a, another alternative embodiment reconfigurable antenna system 670 including a patch antenna element 672 is interconnected to a ground plane 674 via several spaced-apart shorting pins 676, each in the form of inductors and/or capacitors 678 and RF switches 680.

Referring to FIG. 12, another alternative embodiment reconfigurable antenna system 682 provides polarization diversity through two feeds 684 and 686 at mutually perpendicular locations of an antenna element 688. An RF input 690 is selectively interconnected through an RF switch 692 for selection of the polarization of the reconfigurable antenna 682.

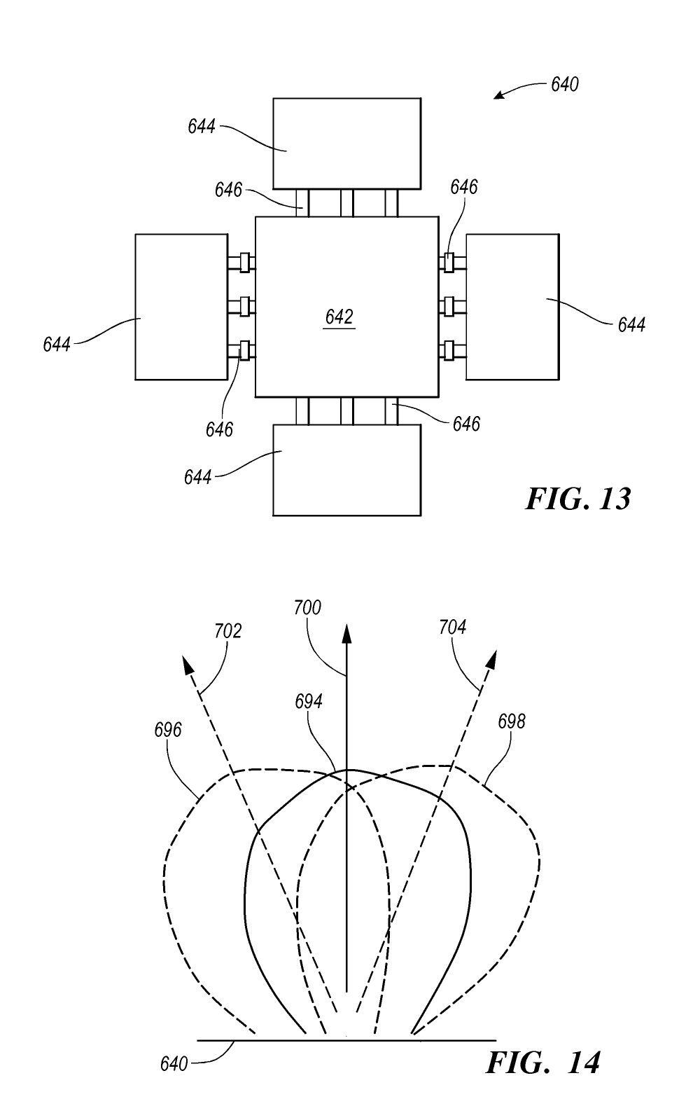

Referring to FIGS. 13 and 14, the reconfigurable antenna system 640 of FIGS. 7 and 7a having resonant and sub-resonant elements 642 and 644 is controlled to achieve directionality of the resulting antenna reception/transmission patterns 694, 696 and 698 along different axes 700, 702 and 704 (by way of example) based on various combinations of RF switch 648 states.

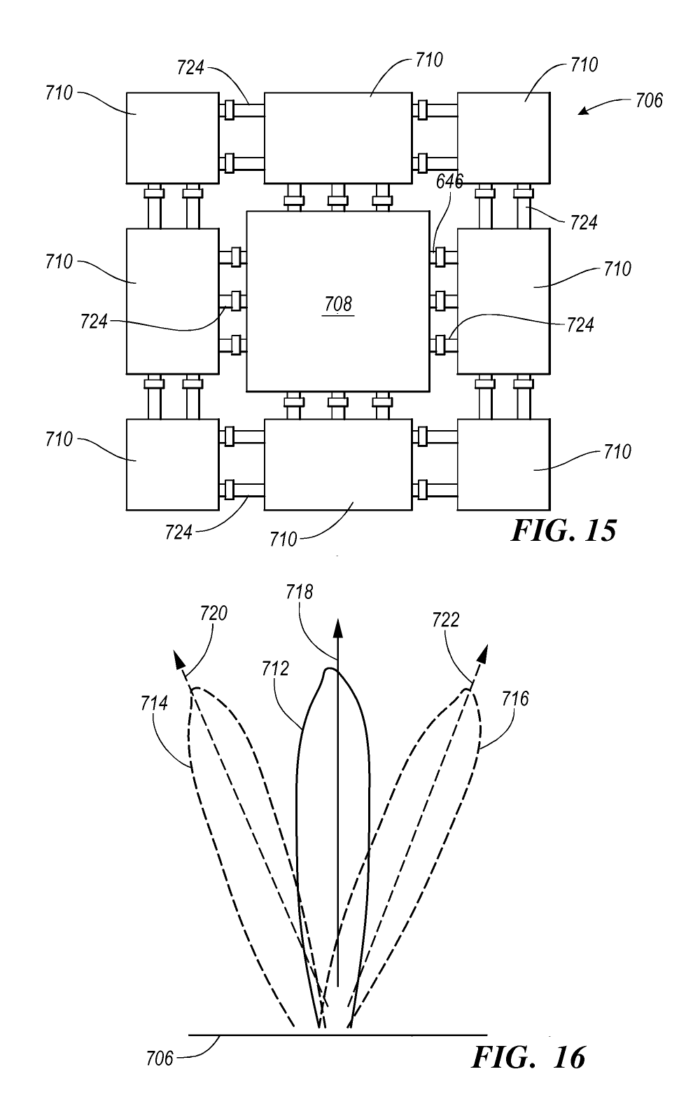

Referring to FIGS. 15 and 16, another alternative embodiment reconfigurable antenna system 706 provides a single, central resonant element 708 surrounded by an array of a number of resonant and/or sub-resonant elements 710. The reconfigurable antenna system 706 is controlled to achieve directionality of the resulting antenna reception/transmission patterns 718, 720 and 722 along different axes 724, 726 and 728 (by way of example) based on various combinations of RF switch 724 states.

While the invention has been specifically described in connection with certain specific embodiments thereof, it is to be understood that this is by way of illustration and not of limitation, and the scope of the appended claims should be construed as broadly as the prior art will permit. It is to be understood that the invention has been described with reference to specific embodiments and variations to provide the features and advantages previously described and that the embodiments are susceptible of modification as will be apparent to those skilled in the art.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. For example, . . . It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

What is claimed is:

1. A multi-beam, cognitive antenna comprising:
a plurality of sub-resonant antenna elements;
a plurality of switching elements arranged with the antenna elements to, when selectively closed, couple selected ones of the antenna elements to one another to generate a multi-element cognitive antenna configuration;
a controller operative to continuously monitor signals received from said antenna configuration, to compare said signals to preset performance thresholds, and to actively reset the conductive state of said switching elements as a function of the difference between said signals and said performance thresholds,
wherein said controller increases effective gain of the antenna and creates a plurality of discrete beam patterns over a narrow frequency band by actively interconnecting a plurality of said antenna elements.

2. The antenna of claim 1, wherein said antenna operates over a relatively narrow frequency band.

3. The antenna of claim 1, further comprising a reconfigurable feed system operable to affect a plurality of antenna polarizations.

4. The antenna of claim 1, wherein said signals meet said preset performance thresholds.

5. The antenna of claim 1, wherein at least one resonant element and at least one sub-resonant element are always interconnected by at least one switching element.

6. The antenna of claim 1, wherein at least two resonant elements are always interconnected by at least one switching element.

7. The antenna of claim 1, wherein said resonant and sub-resonant elements are disposed in close proximity to one another.

8. The antenna of claim 1, further comprising a reconfigurable feed system operative to feed the antenna configuration at a plurality of locations.

9. The antenna of claim 1, wherein said antenna configuration simultaneously includes both disconnected passive sub-resonant antenna elements and interconnected sub-resonant active antenna elements.

10. The antenna of claim 1, wherein at least some of said switching elements comprise lumped inductors and capacitors.

11. The antenna of claim 1, wherein at least some of said switching elements comprise distributed inductors and capacitors.

12. A method of operating a multi-beam, cognitive antenna comprising the steps of:
forming an antenna including a plurality of sub-resonant antenna elements, a plurality of switching elements arranged with the antenna elements to, when selectively closed, couple selected ones of the antenna elements to one another to generate a multi-element cognitive antenna configuration,
providing a controller operative to continuously monitor signals received from said antenna configuration, to compare said signals to preset performance thresholds, and to actively reset the conductive state of said switching elements as a function of the difference between said signals and said performance thresholds,
wherein said controller increases effective gain of the antenna and creates a plurality of discrete beam patterns over a narrow frequency band by actively interconnecting a plurality of said antenna elements.

13. The method of claim 12, further comprising the step of operating said antenna over a relatively narrow frequency band.

14. The method of claim 12, wherein said reconfigurable feed system is operative to maintain said radio-antenna impedance match.

15. The method of claim 12, further comprising the step of controlling said signals to substantially meet said preset performance thresholds.

16. The method of claim 12, further comprising the step of establishing an electrical connection between at least some of said resonant and/or sub-resonant antenna elements.

17. The method of claim 12, further comprising the step of positioning said sub-resonant antenna elements in close proximity to one another.

18. The method of claim 12, further comprising the step of configuring said antenna to simultaneously include both disconnected passive sub-resonant antenna elements and interconnected sub-resonant active antenna elements.

19. The method of claim 12, further comprising the step of providing at least some of said switching elements with lumped inductors and capacitors.

20. The method of claim 12, further comprising the step of providing at least some of said switching elements with distributed inductors and capacitors.

21. The antenna of claim 1, wherein said antenna selectively changes its effective aggregate size and component count by actively connecting and disconnecting resonant and/or sub-resonant antenna elements.

22. The antenna of claim 1, wherein said antenna selectively changes its effective aggregate size and component count by actively connecting and disconnecting lumped inductors and capacitors.

23. The antenna of claim 1, wherein said antenna selectively changes its effective aggregate size and component count by actively connecting and disconnecting distributed inductors and capacitors.

24. The antenna of claim 1, wherein said antenna is a self-structuring antenna and includes a patch element, and wherein said antenna comprises at least one shorting pin including an RF switch with associated capacitors and/or inductors

25. The antenna of claim 1, wherein said sub-resonant antenna elements are controlled to affect a narrow beam spatial-temporal scanning as a function of the conductive states of said switching elements.

26. The antenna of claim 1, further comprising:
a plurality of spaced feed points; and
a plurality of feed switching elements arranged with an antenna element to, when selectively closed, couple selected ones of the feed points to one the antenna element,
wherein the controller is further operative to actively reset the conductive state of said feed switching elements as a function of the difference between said signals and said performance thresholds,
wherein said controller maintains an impedance match between the antenna and an associated radio, and
wherein said controller alters the polarization of the antenna.

27. The antenna of claim 26, wherein said antenna selectively changes its feed points by actively connecting and disconnecting feed elements to affect altering the polarization of the antenna.

28. The antenna of claim 26, wherein said antenna selectively changes its feed points by actively connecting and disconnecting feed elements for the purpose of maintaining an impedance match between the antenna and an associated radio.

29. The antenna of claim 26, wherein said antenna selectively changes its feed points by actively connecting and disconnecting lumped inductors and capacitors.

30. The antenna of claim 26, wherein said antenna selectively changes its feed points by actively connecting and disconnecting distributed inductors and capacitors.

31. A multi-beam, cognitive antenna system comprising:
a plurality of resonant and/or sub-resonant antenna elements, switching elements, and transmission feed lines, wherein the plurality of switching elements are arranged with the antenna elements and transmission feed lines to, when selectively closed, electrically couple selected ones of the antenna elements and transmission feed lines to one another to generate an antenna configuration selected from a plurality of antenna configurations;
a non-volatile memory configured to store data representing at least some of the plurality of antenna configurations;
a control arrangement operatively coupled to the plurality of switching elements to compare said signals to preset performance thresholds, and to actively reset the conductive state of said switching elements as a function of the difference between said signals and said performance thresholds, and further as a function of the data stored in said memory; and
means operative to selectively update said data on a function of previously selected antenna configurations,
wherein said controller affects creation of a power-efficient multi-beam spatial-temporal scanning.

32. The method of claim 12, further comprising the step of configuring said antenna to simultaneously include both disconnected passive resonant antenna elements and interconnected resonant active antenna elements.
